(19) United States
(12) Patent Application Publication
(10) Pub. No.: US 2016/0149634 A1
(43) Pub. Date: May 26, 2016

(54) QUAD-POLARIZED SECTOR AND DIMENSIONAL ANTENNA FOR HIGH THROUGHPUT

(71) Applicant: Vivint, Inc., Provo, UT (US)

(72) Inventors: Venkat Kalkunte, Saratoga, CA (US); Cyril Arokiaraj Arool Emmanuel, Cupertino, CA (US)

(21) Appl. No.: 14/552,266

(22) Filed: Nov. 24, 2014

(51) Int. Cl. H04B 7/155; H04B 7/04

(52) U.S. Cl. CPC H04B 7/1555; H04B 7/0413

(57) ABSTRACT

Systems, apparatuses, and methods are described for communicating with a quad-polarized antenna array using multiple-input, multiple output (MIMO) techniques. One apparatus for wireless communications includes an antenna array for MIMO wireless communication. The antenna array may include a first directional antenna having an orthogonal polarization, wherein the first directional antenna is pointed in a first direction. The antenna array may also include a second directional antenna having an orthogonal polarization, wherein the second directional antenna is pointed in a second direction different than the first direction. The quad-polarized antenna arrays described herein may be deployed in outdoor environments and achieve high throughput.

### BACKGROUND

The present disclosure relates generally to multiple-input multiple-output (MIMO) antenna systems. MIMO technology offers channel capacity and channel throughput enhancements that are able to be utilized under rich multipath channel characteristics and a number of MIMO signal paths for the particular MIMO system. Indoor environments may have rich multipath channel characteristics due to abundant sources of multipath found in indoor environments. From an antenna design perspective, there may be no special requirements in a MIMO antenna design in order to meet system requirements indoors. Therefore, commercial-off-the-shelf (COTS) antennas are extensively used in indoor applications and yield high throughputs.

However, outdoor environments are largely free space, line-of-sight (LOS) links without significant multipath channel characteristics. Hence, COTS antennas do not meet the MIMO system requirements needed in order to achieve the same MIMO channel capacity and throughputs offered in indoor environments.

### SUMMARY

Embodiments described herein provide antenna system designs with specific gain, radiation patterns, polarization, and spatial diversity characteristics that may be used to achieve similar MIMO channel capacity enhancements offered by indoor environments through effectively harnessing available multipath sources in outdoor environments. Applications that may use embodiments described herein include high throughput (HT) point to multi-point internet distribution systems.

In a first set of illustrative examples, an apparatus for wireless communication is described. In one configuration, the apparatus includes an antenna array for multiple-input, multiple-output (MIMO) wireless communication. The antenna array may include a first directional antenna having an orthogonal polarization, wherein the first directional antenna is pointed in a first direction. The antenna array may also include a second directional antenna having an orthogonal polarization, wherein the second directional antenna is pointed in a second direction different from the first direction.

In some examples of the apparatus, the first directional antenna and the second directional antenna are spatially separated in order to reduce correlation. In another example, the first and second directional antennas transmit and receive the wireless communications over four spatial streams. In some examples the first and second directions are approximately antiparallel while in other examples the first and second directions are approximately 45 degrees apart.

The antenna array of the apparatus may be an access point, wherein the first and second directional antennas transmit and receive MIMO wireless communications to and from a station comprising a single directional antenna with quad polarities. In some examples, the antenna array is one of an access point and a station. In some examples of the apparatus, a boresight of the antenna array is rotated approximately ninety degrees with respect to a receiving station. In certain examples of the apparatus, the first directional antenna and the second directional antenna each include two dipole antennas.

In a second set of illustrative examples, an apparatus for multiple-input multiple-output (MIMO) communications is described. In one configuration, the apparatus may include an antenna array comprising four dipole antennas having slant vertical polarization configured orthogonally.

In a third set of illustrative examples, an multiple-input multiple-output (MIMO) wireless communication system is described. In one configuration, the system includes an access point and a station configured to communication with the access point. The access point may further include a first directional antenna having an orthogonal polarization, wherein the first directional antenna is pointed in a first direction. The access point may also include a second directional antenna having an orthogonal polarization, wherein the second directional antenna is pointed in a second direction different from the first direction.

In a fourth set of illustrative examples, a method for wireless communication is described. In one configuration, the method includes determining a signal to be transmitted. The method may also include transmitting the signal using a first directional antenna having an orthogonal polarization and pointing in a first direction and a second directional antenna having an orthogonal polarization pointing in a second direction, wherein the second direction is different from the first direction.

In a fifth set of illustrative examples, a method for wireless communication is described. In one configuration, the method includes receiving a signal using a first directional antenna having an orthogonal polarization and pointing in a first direction and a second directional antenna having an orthogonal polarization pointing in a second direction, wherein the second direction is different from the first direction.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures, systems, and processes for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of an example wireless communications network according to an embodiment of the present disclosure.

FIG. 2 shows a block diagram of an example wireless communications system including quad-polarized antennas according to an embodiment of the present disclosure.

FIG. 3 shows a block diagram of another example wireless communications system of FIG. 2 according to an embodiment of the present disclosure.

FIG. 4 shows a block diagram of another example of a wireless communications system including quad-polarized antennas according to an embodiment of the present disclosure.

FIG. 5 shows a conceptual diagram of an example antenna system according to an embodiment of the present disclosure.

FIG. 6 shows a block diagram of an example wireless communications system using the antenna system of FIG. 5 according to an embodiment of the present disclosure.

FIG. 7 shows a block diagram of an example of a single quad-polarized antenna according to an embodiment of the present disclosure.

FIG. 8 shows a conceptual diagram of example radiation pattern in a wireless communications system according to an embodiment of the present disclosure.

FIG. 9 shows a block diagram of an example of an access point for use in wireless communication according to an embodiment of the present disclosure.

FIG. 10 shows a block diagram of an example of a station for use in wireless communication according to an embodiment of the present disclosure.

FIG. 11 shows a flowchart of an example method to transmit signals using a quad-polarized antenna system according to an embodiment of the present disclosure.

FIG. 12 shows a flowchart of an example method to receive signals using a quad-polarized antenna system according to an embodiment of the present disclosure.

While the embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION

The apparatuses, systems, methods described herein relate to antenna systems for wireless communications. More specifically, the systems, the apparatus, and the methods described here relate to quad-polarized sector and directional antennas.

An application of an outdoor communication system may require a high throughput point to multi-point Internet distribution system. In order to achieve high throughput, highly stable high throughput MIMO links between an access point (e.g., a micro site AP) and a station (e.g., a customer premises equipment) may be required. Previous solutions based on COTs antennas result in time-variant, low throughputs impacting the Internet usage of the customers. Apparatus, systems, and techniques described herein provide a unique antenna system that is designed with specific gains, radiation patterns, polarization, and spatial diversity characteristics that achieve MIMO channel capacity in the outdoor environment that enables high throughput point to multi-point communications.

To achieve the MIMO channel capacity in the outdoor environment, antenna characteristics of gain, polarization, radiation pattern, and spatial separation are selected to translate the MIMO capabilities of a WLAN radio over the outdoor wireless channel between an AP and a station. The antenna characteristics may include maximum ratio combining (MRC), transmit beamforming (TxBF), and spatial division multiplexing (SDM). The antenna characteristics may be selected to achieve peak physical layer (PHY) rates, higher signal-to-noise ratio (SNR), and stable modulation and coding scheme (MCS) rates over the outdoor wireless channel between the access point and the station.

When the antenna systems are fully correlated due to small local angle spread, a rank of the MIMO channel drops, causing a reduction in channel capacity and throughput. The antenna system may become fully correlated due to like-polarization and/or inadequate spatial separation among the antennas in the array of the antenna system. Both diversity and multiplexing gains may vanish, maintaining only the antenna array gain. When an antenna system is fully coordinated, it may act as a regular single-input, single-output (SISO) outdoor system.

In order to reduce correlation and improve MIMO channel capacity, antenna arrays are described herein that are quad-polarized and may have spatial separation. These antenna array designs may have specific gain, radiation patterns, polarization, and spatial diversity characteristics in order to achieve similar MIMO channel capacity enhancements offered by indoor environments through effectively harnessing available multipath sources in outdoor environments. A quad-polarized antenna array may include four dipole antennas arranged in a particular configuration in order to improve the MIMO channel capacity.

Any discussion of any apparatus, system, method, and/or other characteristic discussed with respect to one type (e.g., network 100) is not limiting and applies to every other discussion of that same type (e.g., a network) or any other type (e.g., a method).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

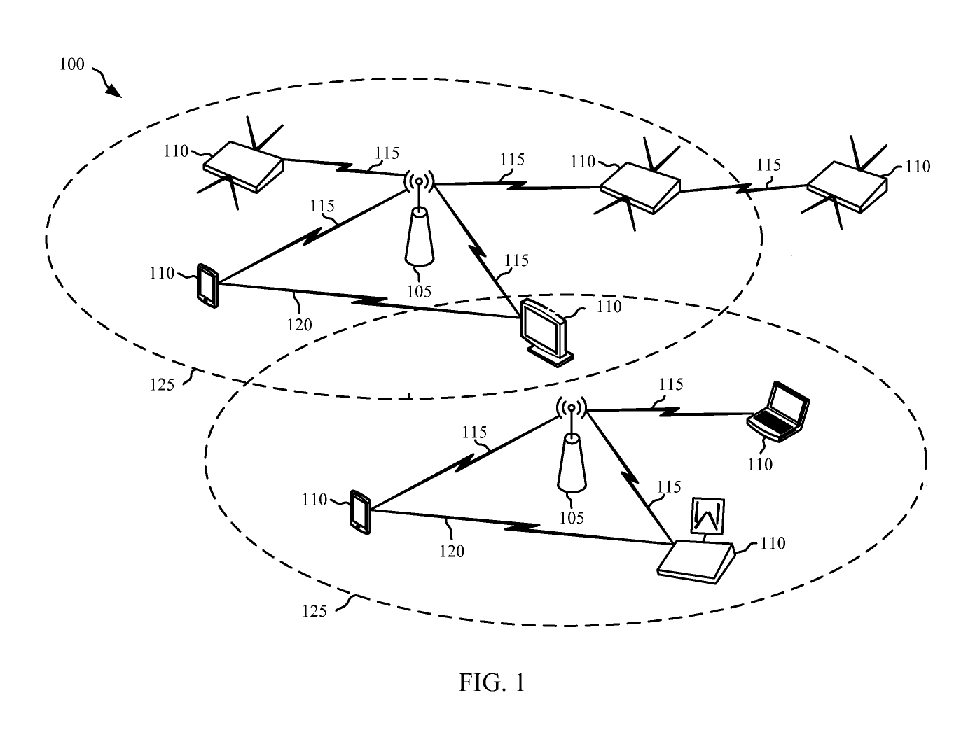

Referring now to the figures in particular, FIG. 1 shows a block diagram of an example wireless communications network 100 according to an embodiment of the present disclosure. The example network 100 may be an example of a radio access network. More specifically, the network 100 may be an example of a WLAN network. In other examples, the network 100 may be an example of a cellular network. The network 100 may be applied in an outdoor environment and may use multiple-input, multiple-output (MIMO) techniques.

The network 100 may include one or more access points (AP) 105 and one or more wireless devices or stations (STAs) 110. The stations 110 may be such as mobile stations, personal digital assistants (PDAs), other handheld devices, netbooks, notebook computers, tablet computers, laptops, display devices (e.g., TVs, computer monitors, etc.), printers, and the like. While two APs 105 are illustrated, the network 100 may have just one or more than two APs 105. Each of the wireless stations 110, which may also be referred to as stations, mobile stations (MSs), mobile devices, access terminals (ATs), user equipment (UE), subscriber stations (SSs), customer premises equipments (CPEs), or subscriber units, may associate and communicate with an AP 105 via a communication link 115. Each AP 105 has a geographic coverage area 125 such that the stations 110 within that area can typically communicate with the AP 105. The stations 110 may be dispersed throughout the geographic coverage area 125. Each station 110 may be stationary or mobile. The network 100 may provide network communication to another, external network (e.g., the Internet).

A station 110 can be covered by more than one AP 105 and can therefore associate with one or more APs 105 at different times. A single AP 105 and an associated set of stations 110 may be referred to as a basic service set (BSS). An extended service set (ESS) is a set of connected BSSs. A distribution system (DS) may be used to connect APs 105 in an extended service set. A geographic coverage area 125 for an access point 105 may be divided into sectors making up only a portion of the coverage area. The WLAN network 100 may include access points 105 of different types (e.g., metropolitan area, home network, etc.), with varying sizes of coverage areas and overlapping coverage areas for different technologies. Other wireless devices can communicate with the AP 105.

While the stations 110 may communicate with each other through the AP 105 using communication links 115, each station 110 may also communicate directly with one or more other stations 110 via a direct wireless link 120. Two or more stations 110 may communicate via a direct wireless link 120 when both stations 110 are in the AP geographic coverage area 125 or when one or neither station 110 is within the AP geographic coverage area 125. Examples of direct wireless links 120 may include Wi-Fi Direct connections, connections established by using a Wi-Fi Tunneled Direct Link Setup (TDLS) link, and other P2P group connections. The stations 110 in these examples may communicate according to the WLAN radio and baseband protocol including physical and MAC layers. In other implementations, other peer-to-peer connections and/or ad hoc networks may be implemented within the network 100.

In some examples, one or more of the APs 105 and the stations 110 may include an antenna array that is quad-polarized. That is, the antenna array may include four antennas that may be polarized in different directions. The APs 105 and the stations 110 may transmit and receive signals using MIMO techniques. The APs 105 and the stations 110 may communicate using three or four spatial streams, for example. In other examples, one or more of the APs 105 and the stations 110 may include an antenna array having different numbers of antennas.

In the network 100 described herein, high throughput may be achieved in an outdoor environment through the use of MIMO techniques with the unique antenna system designs as described herein. The antenna systems may have specific gain, radiation pattern, polarization, and spatial diversity characteristics. In some examples, the network 100 may be a HT (high throughput) point to multi-point internet distribution system. The network 100 may achieve similar MIMO channel capacity enhancements that are offered by indoor environments in an outdoor environment by effectively harnessing the available multipath sources in the outdoor environment.

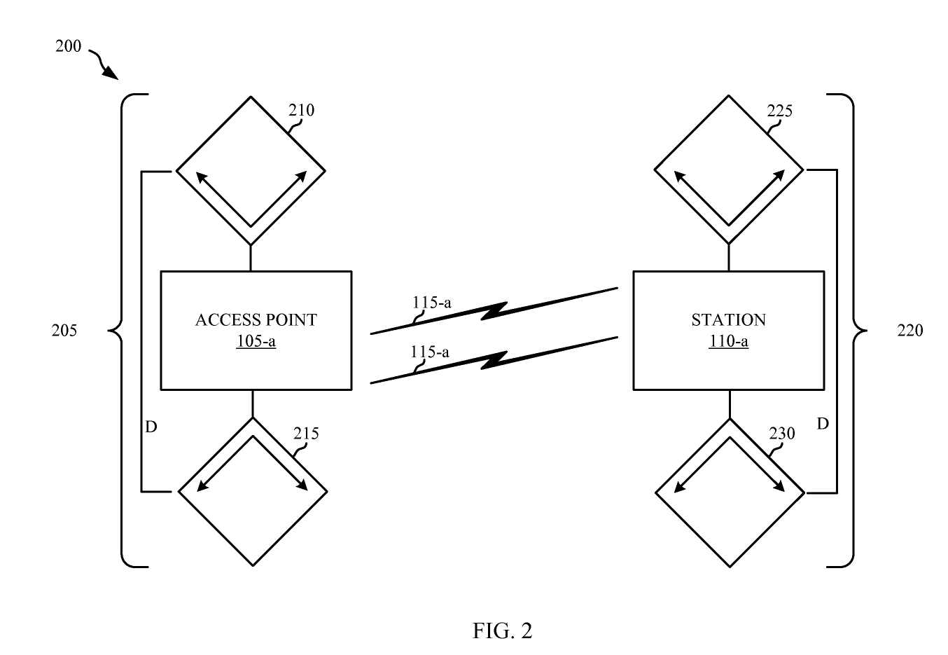

FIG. 2 shows a block diagram of an example of a wireless communications system 200 including quad-polarized antennas according to an embodiment of the present disclosure. The wireless communication system 200 may include an access point 105-a and a station 110-a that communicate via one or more communication links 115-a. In some examples, the system 200 may be an example of one or more aspects of the system 100 described with reference to FIG. 1. In some embodiments, the AP 105-a may be an example of one or more aspects of the APs 105 described with reference to FIG. 1. In further embodiments, the station 110-a may be an example of one or more aspects of the stations 110 described with reference to FIG. 1. In some embodiments, the communication links 115-a may be an example of one or more aspects of the communication links 115 described with reference to FIG. 1.

The AP 105-a includes an antenna array 205 including a first directional antenna 210 and a second directional antenna 215. A directional antenna is an antenna that radiates more power in one particular direction. The first directional antenna 210 and the second directional antenna 215 may each comprise two dipole antennas. In this example, the first directional antenna 210 and the second directional antenna 215 have orthogonal polarizations.

The first directional antenna 210 points in a first direction and the second directional antenna 215 points in a second direction. The direction a directional antenna points in is defined herein as the direction in which a lobe of the antenna with the greatest power points. In the example shown in FIG. 2, the first direction and the second direction are anti-parallel. In other examples, the first direction and the second direction may be perpendicular. Other examples may include the first direction and the second direction being any angle apart that still supports MIMO capabilities.

The first directional antenna 210 and the second directional antenna 215 are also spaced a distance D apart. The first directional antenna 210 and the second directional antenna 215 are spatially separated by D in order to reduce correlation in the antenna array 205. In some examples, D may be up to and including approximately 150 millimeters (mm) apart. In other examples, D may be other distances.

The orthogonality and the spatial separation D may ensure minimal correlation between the first directional antenna 210 and the second directional antenna 215. In one example, the first directional antenna 210 and the second directional antenna 215 have 3-dB bandwidth characteristics and a gain such that the AP 105-a provides the required high signal-to-noise ratio (SNR) to sustain up to four spatial streams resulting in very high throughputs. For example, a 16 dBi quad pol directional antenna operating in frequencies of approximately 5000 MHz to approximately 6000 MHz may have gains from 1.5 dB to 17 dB, depending on the orientation of the antenna and the presence or absence of reflectors or attenuators. In other examples, other gains may be achieved.

The station 110-a includes an antenna array 220 including two directional antennas. The antenna array 220 includes a third directional antenna 225 and a second directional antenna 230. The third directional antenna 225 and the second directional antenna 230 may each comprise two dipole antennas.

The third directional antenna 225 and a second directional antenna 230 may have orthogonal polarizations. The third directional antenna 225 points in a third direction and the second directional antenna 230 points in a fourth direction. In some examples, the third directional antenna 225 points approximately in the same direction as the first directional antenna 210 and the fourth directional antenna 230 points approximately in the same direction as the second directional antenna 215. In the example shown in FIG. 2, the first direction and the second direction are anti-parallel. In other examples, the first direction and the second direction may be perpendicular. In yet another example, the first direction and the second direction are approximately 45 degrees apart. Other examples may include the first direction and the second direction being any angle apart that still supports MIMO capabilities.

The third directional antenna 225 and the fourth directional antenna 230 are also spaced a distance D apart. The third directional antenna 225 and the fourth directional antenna 230 are spatially separated by D in order to reduce correlation in the antenna array 220. In other examples, the third directional antenna 225 and a second directional antenna 230 are spaced a different distance apart than the first directional antenna 210 and the second directional antenna 215 are spaced.

The antenna arrays 205 and 220, having the orthogonal polarizations configured as shown in FIG. 2, may achieve an improved angular spread that enables capture of the scattering effect from any available multipath sources in the environment in which the system 200 is deployed. For example, the orthogonal polarizations of the antenna arrays 205 and 220 may capture scattering effects from sources in an outdoor wireless medium between the AP 105-a and the station 110-a.

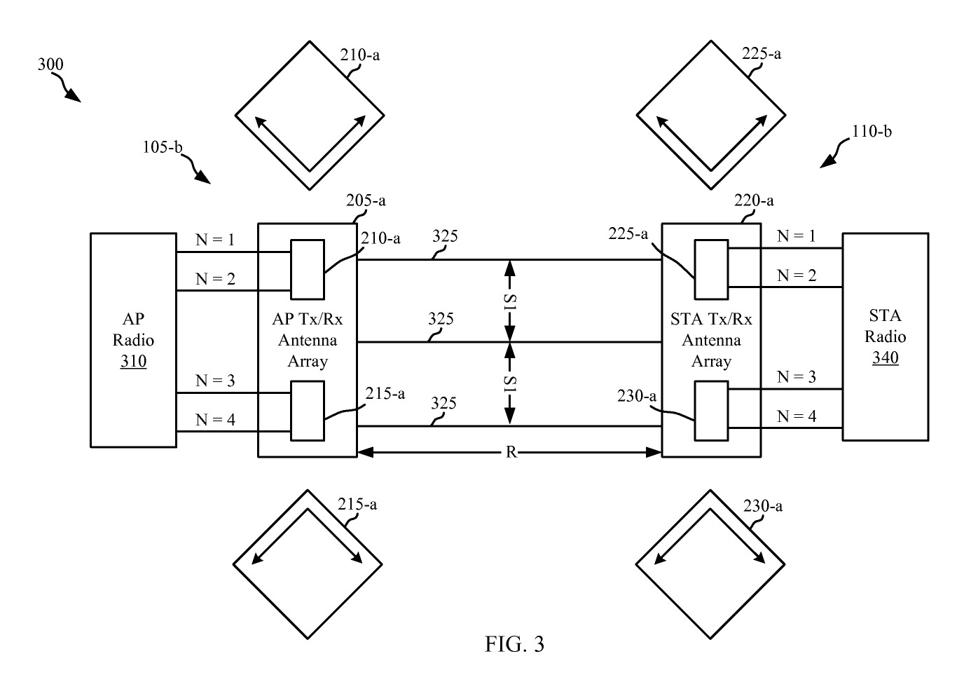

FIG. 3 shows a block diagram of another example wireless communications system 300 according to an embodiment of the present disclosure. The wireless communication system 300 may include an access point 105-b and a station 110-b. In some examples, the system 300 may be an example of one or more aspects of the system 100 and 200 described with reference to FIGS. 1 and 2, respectively. In some embodiments, the AP 105-b may be an example of one or more aspects of the APs 105 and the station 110-b may be an example of one or more aspects of the stations 110 described with reference to FIGS. 1 and 2.

The AP 105-b includes an AP radio 310 and an antenna array 205-a. In some embodiments, the antenna array 205-a may be an example of one or more aspects of the antenna array 205 described with reference to FIG. 2. The antenna array 205-a includes a first directional antenna 210-a and a second directional antenna 215-a. In FIG. 3, the first directional antenna 210-a and the second directional antenna 215-a are shown with a side perspective within the antenna array 205-a. Additionally, the first directional antenna 210-a and the second directional antenna 215-a are shown with a front perspective above and below the antenna array 205-a in order to illustrate the directionality and polarization of the directional antennas 210-a and 215-a.

The AP radio 310 may be a transceiver that is coupled to the antenna array 205-a. The AP radio 310 may send control signals to the antenna array 205-a in order to set parameters for the antenna array 205-a and to instruct the antenna array 205-a to transmit one or more signals. The antenna array 205-a may also receive signals and provide them to the AP radio 310. The AP radio 310 may include, or be coupled to, a processor, as described below with respect to FIG. 8.

The AP radio 310 may determine a signal for transmitting. The AP radio 310 may multiplex the signal into four different portions, N=1 through N=4. Each portion of the multiplexed signal may be provided to a dipole of the antenna array 205-a. For example, signals N=1 and N=2 are provided to the first directional antenna 210-a and the signals N=3 and N=4 are provided to the second directional antenna 215-a.

The STA 110-b includes an STA radio 340 and an station transmit/receive antenna array 220-a. In some embodiments, the STA antenna array 220-a may be an example of one or more aspects of the antenna array 220 described with reference to FIG. 2. The STA antenna array 220-a includes a third directional antenna 225-a and a fourth directional antenna 230-a. In FIG. 3, the third directional antenna 225-a and the fourth directional antenna 230-a are shown with a side perspective within the antenna array 220-a. Additionally, the third directional antenna 225-a and the fourth directional antenna 230-a are shown with a front perspective above and below the antenna array 220-a in order to illustrate the directionality and polarization of the directional antennas 225-a and 230-a.

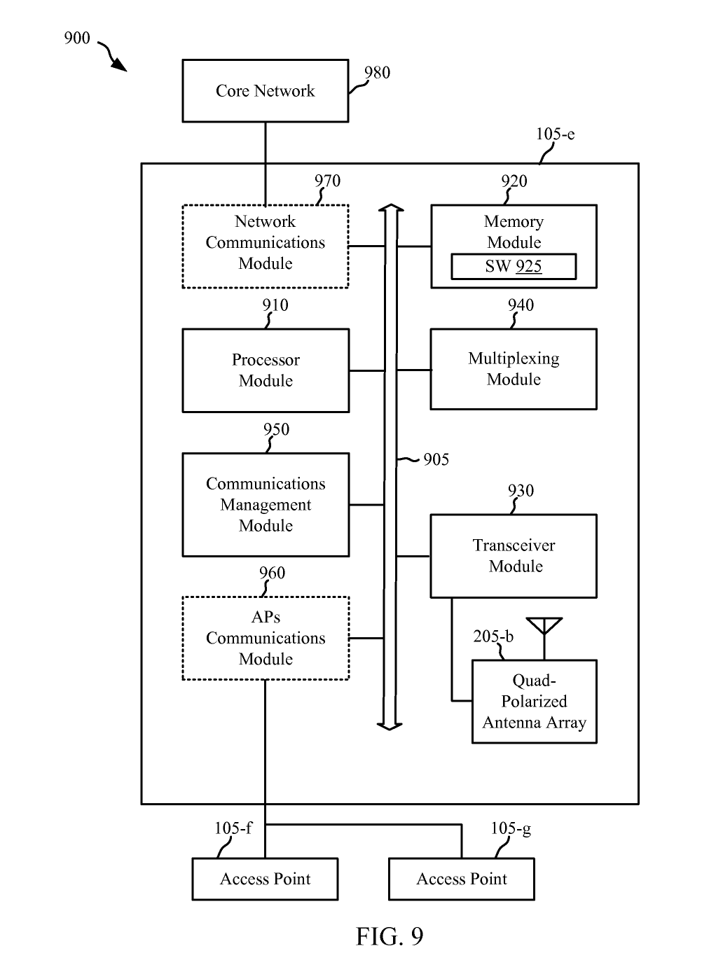

The STA radio 340 may be a transceiver that is coupled to the STA antenna array 220-a. The STA radio 310 may send control signals to the STA antenna array 220-a in order to set parameters for the antenna array 220-a and to instruct the STA antenna array 220-a to transmit one or more signals. The STA antenna array 220-a may also receive signals and provide them to the STA radio 340. The STA radio 340 may include, or be coupled to, a processor, as described below with respect to FIG. 9.

In this example, the STA radio 340 may receive a transmitted multiplexed signal. The STA radio 340 may inverse multiplex the four signals, N=1 through N=4, into a single signal. Each portion of the multiplexed signal may be received by a dipole of the antenna array 220-a. For example, signals N=1 and N=2 are received at the third directional antenna 225-a and the signals N=3 and N=4 are received at the fourth directional antenna 230-a.

The AP antenna array 205-a may transmit the signals to the STA antenna array 220-a over MIMO channels 325. The channels 325 may be a distance of S1 apart. In some examples, the distance S1 may be dependent upon wireless regulations. In this example, the AP 105-b transmits the signals, N=1 through N=4, to the station 110-b. However, in other examples, the STA 110-b may transmit the signals to the AP 105-b. In some examples, if obstacles are present in the outdoor wireless environment (such as foliage), the AP antenna array 205-a may increase the power with which the signals are transmitted.

The AP antenna array 205-a may be located a distance R from the STA antenna array 220-a. The distance R may be, for example, 80 meters (m). For example, the range may be up to 700 m or more for a line of sight and having 50 Megabits per second (Mbps) service. Other examples may achieve other ranges. The STA 110-b may be in line of sight (LOS) of the AP 105-b. The STA 110-b and the AP 105-b may both be deployed in an outdoor environment. In other examples, one or both the STA 110-b and the AP 105-b are deployed indoors. The system 300 is able to leverage any multipath characteristics in the environment of the STA 110-b and the AP 105-b in order to achieve MIMO advantages.

One example of potential specifications of one or more of the directional antennas 210-a, 215-a, 225-a, and 230-a is as follows. A frequency range may be 5.15-5.875 Giga Hertz (GHz) with a gain of 12.5±0.5 dBi. A maximum voltage standing wave ratio (VSWR) may be 1.7:1. A polarization of the antenna may be dual, vertical, and horizontal. A 3 dB beam-width may have azimuth (Az-Plane) of typ. 120° and elevation (El-Plane) of typ. 15°. A cross polarization typ. may be −15 dB, a minimum front-to-back ratio may be −30 dB, and a port-to-port isolation typ. may be −25 dB. These example parameters are given for illustrative purposes only. In other examples, one or more of the directional antennas 210-a, 215-a, 225-a, and 230-a may have different parameters.

In some applications of the system 300, four spatial streams are achievable in the channel between the AP 105-b and the STA 110-b. In some examples, transmit beamforming (TxBF) for the transmitting AP 105-b and/or the STA 110-b may be turned on. When TxBF is turned on, the MIMO channel may support different per spatial stream modulation and coding scheme (MCS) rates. That is, the MCS rates for two or more of the spatial streams may be unequal. The unequal MCS rates may make the link between the AP 105-b and the STA 110-b more robust against interference.

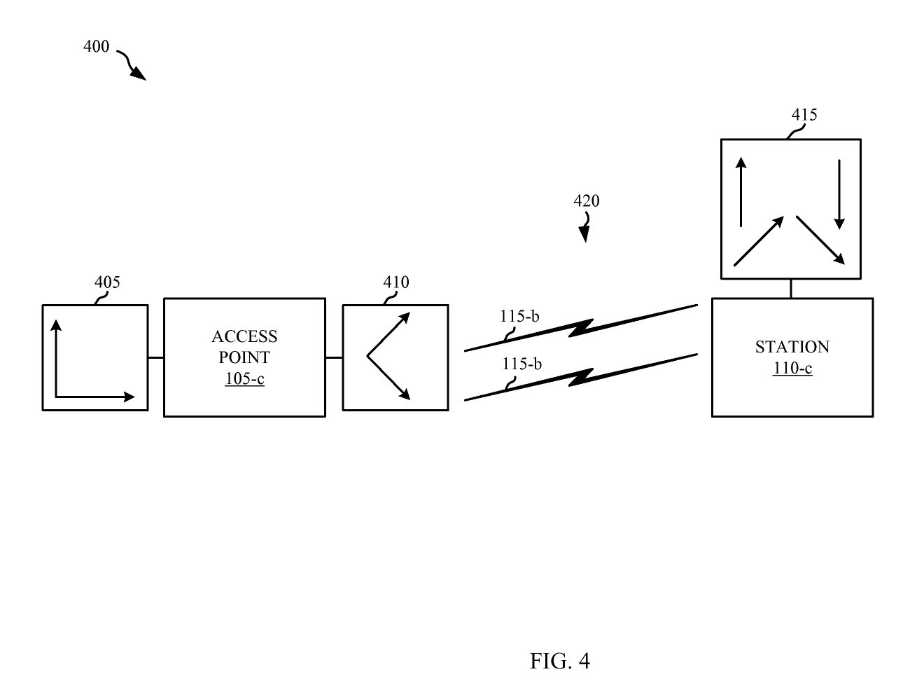

FIG. 4 shows a block diagram of another example of a wireless communications system 400 including quad-polarized antennas according to an embodiment of the present disclosure. The wireless communication system 400 may include an access point 105-c and a station 110-c. In some examples, the system 400 may be an example of one or more aspects of the system 100 described with reference to FIG. 1. In some embodiments, the AP 105-c may be an example of one or more aspects of the APs 105 and the station 110-c may be an example of one or more aspects of the stations 110 described with reference to FIGS. 1-3.

The AP 105-c includes two directional antennas, a directional antenna 405 and a directional antenna 410. The directional antennas 405 and 410 have orthogonal polarizations. The directional antennas 405 and 410 may be spaced apart and configured as shown in FIG. 4. That is, the directional antenna 405 may have a boresight in a first direction, and the directional antenna 410 may have a boresight in a second direction, wherein the second direction is approximately 45 degrees rotated from the first direction.

The AP 105-c may transmit one or more signals to the STA 110-c over one or more communication links 115-b. In some examples, the communication links 115-b may be an example of one or more aspects of the communication links 115 described with reference to FIGS. 1 and 2. An outdoor wireless medium 420 may exist between the AP 105-c and the STA 110-c.

The station 110-c includes a single directional antenna 415. The directional antenna 415 has quad polarities arranged in a configuration as shown in FIG. 4. The quad polarities of the directional antenna 415 may be used to achieve an angular spread that may capture the scattering effect from any available multipath sources in the outdoor wireless medium 420 between the AP 105-c and the STA 110-c.

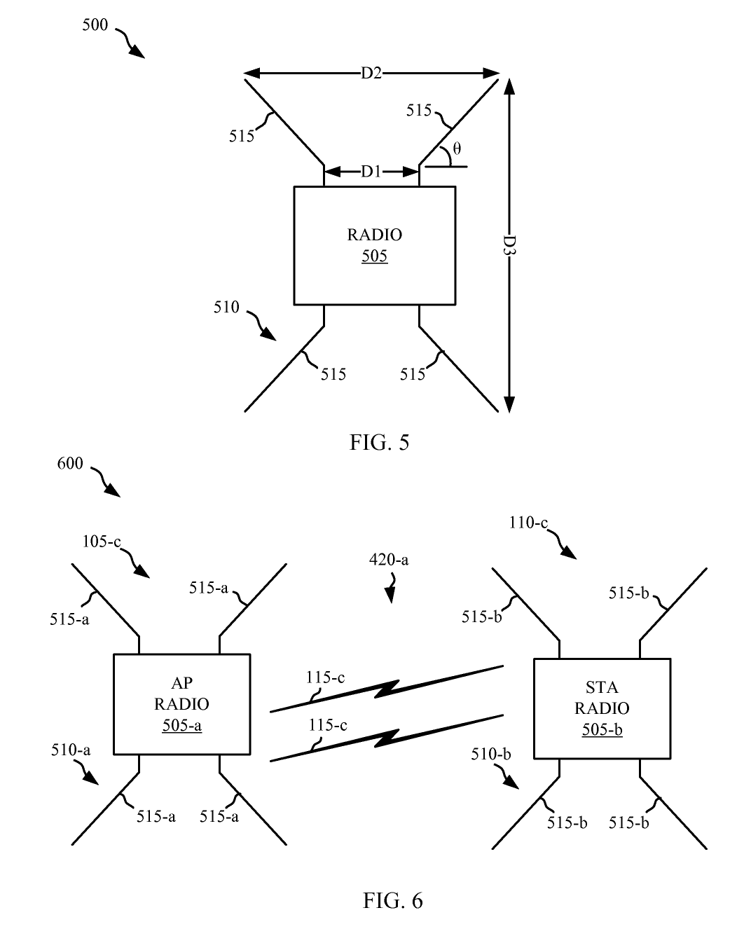

FIG. 5 shows a conceptual diagram of an example antenna system 500 including a radio 505 including an antenna array 510 according to an embodiment of the present disclosure. The antenna system 500 may be part of an access point or a station, that is, the antenna system 500 may be an example of one or more aspects of the APs 105 and the stations 110 described with reference to FIGS. 1-4. In some examples, the radio 505 may be an example of one or more aspects of the AP radio 310 or the STA radio 340 described with reference to FIG. 3. The antenna array 510 may be an example of one or more aspects of the AP antenna array 205 or the STA antenna array 220 described with reference to FIGS. 2 and 3.

The antenna array 510 may include four antennas 515. The antennas 515 may be dipole antennas and may be arranged as is shown in FIG. 5. In some embodiments, the antennas 515 may be an example of one or more aspects of the antennas 210, 215, 225, 230, 405, 410, and 415 described with reference to FIGS. 2-4.

As shown in FIG. 5, the antennas 515 may be positioned at an angle CI from a horizontal plane defined by the radio 505. The angle θ may be, for example, 45°. In other examples, other values of the angle θ are used. The base of two of the antennas 515 on the same side of the radio 505 may be spatially separated a distance D1 apart. The ends of two of the antennas 515 on the same side of the radio 505 may be spatially separated a distance D2 apart. In this example, D2 is larger than D1. The ends of the antennas 515 located on opposite sides of the radio 505 may be spatially separated a distance D3 apart. The spatial separations of D1 through D3 may result in improved MIMO capabilities of the radio 505 and reduced correlation between the antennas 515.

FIG. 6 shows a block diagram of an example wireless communications system 600 using the antenna system 500 of FIG. 5 according to an embodiment of the present disclosure. The wireless communications system 600 may include an AP 105-c and a STA 110-c. In some examples, the system 600 may be an example of one or more aspects of the system 100 described with reference to FIG. 1. In some embodiments, the AP 105-c may be an example of one or more aspects of the APs 105 and the station 110-c may be an example of one or more aspects of the stations 110 described with reference to FIGS. 1-3.

The AP 105-c may include an AP radio 505-a and an antenna array 510-a. The antenna array 510-a may include four dipole antennas 515-a. In some examples, the AP radio 505-a may be an example of one or more aspects of the radio 505 described with reference to FIG. 5. In some embodiments, the antenna array 510-a may be an example of one or more aspects of the antenna array 510 and the four dipole antennas 515-a may be an example of one or more aspects of the four dipole antennas 515 described with reference to FIG. 5.

The STA 110-c may include an STA radio 505-b and an antenna array 510-b. The antenna array 510-b may include four dipole antennas 515-b. In some examples, the STA radio 505-b may be an example of one or more aspects of the radio 505 described with reference to FIG. 5. In some embodiments, the antenna array 510-b may be an example of one or more aspects of the antenna array 510 and the four dipole antennas 515-b may be an example of one or more aspects of the four dipole antennas 515 described with reference to FIG. 5.

The AP radio 505-a may instruct the four dipole antennas 515-a to transmit or receive one or more signals over communication links 115-c. In some examples, the communication links 115-c may be an example of one or more aspects of the communication links 115 described with reference to FIGS. 1, 2, and 4. Similarly, the STA radio 505-b may instruct the four dipole antennas 515-b to transmit or receive one or more signals over the communication links 115-c.

The system 600 therefore may include the AP 105-c with the antenna array 510-a that has a slant vertical polarization configured orthogonally to achieve the optimum angular spread to capture the scattering effect from the available multipath sources in a wireless medium 420-a between the AP 105-c and the STA 110-c. The wireless medium 420-a may be an outdoor wireless medium and may be an example of one or more aspects of the wireless medium 420 described with reference to FIG. 4. The orthogonality and spatial separation of the dipole antennas 515 provide reduced correlation, which along with the overall gain of the antennas 515 may provide a high SNR that may be used to sustain three or four spatial streams. The reduced correlation and the plurality of spatial streams may result in higher throughputs in outdoor environments. In some examples, the system 600 may be used for low cost, medium throughput outdoor applications that have communication link 115-c distances of approximately 80 m or less. The system 600 may be used in other applications as well.

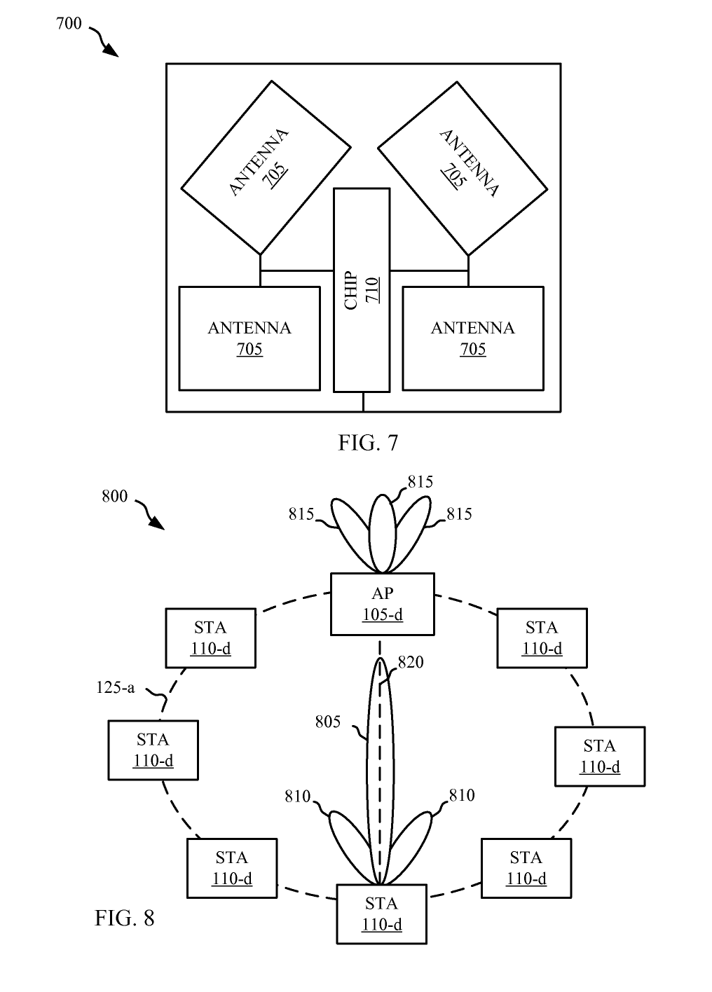

FIG. 7 shows a block diagram of an example of a single quad-polarized antenna 700 according to an embodiment of the present disclosure. The quad-polarized antenna 700 may be part of an access point or a station. In some examples, the quad-polarized antenna 700 may be an example of one or more aspects of the AP antenna array 205, the STA antenna array 220, and/or the single antenna array 415 described with reference to FIGS. 2-4.

The quad-polarized antenna 700 may include four antennas 705 positioned as is shown in FIG. 6. The quad polarities of the quad-polarized antenna 700 may be used to achieve an angular spread that may capture the scattering effect from any available multipath sources in a wireless medium between the quad-polarized antenna 700 and another antenna array. The quad-polarized antenna 700 may further include a chip 710 that may be or include a processor. The chip 710 may control the antennas 705 via control signals. The chip 710 may also provide multiplexed signals for the antennas 705 to transmit and the chip 710 may receive multiplexed signals received at the antennas 705.

FIG. 8 shows a conceptual diagram of example radiation pattern in a wireless communications system 800 according to an embodiment of the present disclosure. The wireless communications system 800 may include an access point 105-d and one or more stations 110 within a coverage area 125-a. In some examples, the wireless communications system 800 may be an example of one or more aspects of the system 100, 200, 300, 400, and/or 600 described with reference to FIGS. 1-4 and 6. In some embodiments, the AP 105-d may be an example of one or more aspects of the APs 105 and the station 110-d may be an example of one or more aspects of the stations 110 described with reference to FIGS. 1-4 and 6. The coverage area 125-a may be an example of one or more aspects of the coverage area 125 described with reference to FIG. 1.

The stations 110-d and the AP 105-d may include a quad-polarized antenna system as described herein. Propagation lobes for example station 110-d are illustrated in FIG. 8. For example, when transmitting, the station 110-d has a front lobe 805 and at least two side lobes 810. The directional antennas that are included in the station 110-d may transmit the front lobe 805 along a boresite 820. The directional antennas of the station 110-d may be pointed toward the AP 105-d. In other examples, the directional antennas of the station 110-d may be pointed in other directions. In such an example, the boresite 820 may point in the other direction. In some examples, the azimuth from the boresight of the quad-polarized antenna system may point 90° from the line-of-sight to another antenna system. In other examples, the azimuth from the boresight of the quad-polarized antenna system may point in another direction from the line-of-sight to the other antenna system, such as 180° (e.g., pointing away).

The AP 105-d may have propagation lobes 815. In some examples, the AP 105-d may have a front lobe that is larger than the side lobes. In some examples, the performance of the side lobes 810 is very good.

The system 800 may have very good MIMO capabilities. The AP 105-d and one or more of the stations 110-d may have horizontal, vertical, −45°, or +45° polarization. The AP 105-d may have enough processing capacity to send four spatial streams to each client station 110-d. The AP 105-d and one or more of the stations 110-d may have an improved gain based on a directional gain, a polarity gain, a beamforming gain, and an antenna gain. In some examples, the antenna gain shown in FIG. 8 has the radiation pattern of the lobes 805, 810, and 815. In some examples, a sector antenna of the station 110-d or the AP 105-d may be pointed in a certain direction and may have a 360° sweep. In some examples, one or more of the antennas may be tuned to achieve specific MIMO capabilities and/or lobe propagation.

FIG. 9 shows a block diagram 900 of an example of an access point 105-e for use in wireless communication according to an embodiment of the present disclosure. In some aspects, the AP 105-e may be an example of the APs 105 of FIGS. 1-4, 6, and 8. The AP 105-e may include a processor module 910, a memory module 920, a transceiver module 930, and a quad-polarized antenna array 205-b. The quad-polarized antenna array 205-b may be an example of the antenna arrays 205 of FIGS. 2 and 3, an example of the single quad-polarized antenna 415 of FIG. 4, and/or an example of the single quad-polarized antenna 510 of FIGS. 5 and 6. In some examples, the AP 105-e may also include one or both of an APs communications module 960, a network communications module 970, and a multiplexing module 940. Each of these modules may be in communication with each other, directly or indirectly, over at least one bus 905.

The memory module 920 may include random access memory (RAM) and read-only memory (ROM). The memory module 920 may also store computer-readable, computer-executable software (SW) code 925 containing instructions that are configured to, when executed, cause the processor module 910 to perform various functions described herein for communicating in a high throughput 4×4 MIMO application, for example. Alternatively, the software code 925 may not be directly executable by the processor module 910 but be configured to cause the computer, e.g., when compiled and executed, to perform functions described herein.

The processor module 910 may include an intelligent hardware device, e.g., a central processing unit (CPU), a microcontroller, an ASIC, etc. The processor module 910 may process information received through the transceiver module 930, the APs communications module 960, and/or the network communications module 970. The processor module 910 may also process information to be sent to the transceiver module 930 for transmission through the quad-polarized antenna array 205-b, to the APs communications module 960, and/or to the network communications module 970. The processor module 910 may handle, alone or in connection with the multiplexing module 940, various aspects related to transmitting and receiving multiplexed signals via the quad-polarized antenna array 205-b. The processor module 910 may also handle tuning the quad-polarized antenna array 205-b.

The transceiver module 930 may include a modem configured to modulate the packets and provide the modulated packets to the quad-polarized antenna array 205-b for transmission, and to demodulate packets received from the quad-polarized antenna array 205-b. The transceiver module 930 may be implemented as at least one transmitter module and at least one separate receiver module. The transceiver module 930 may be configured to communicate bi-directionally, via the quad-polarized antenna array 205-b, with at least one wireless station 110 as illustrated in FIGS. 1-4, 6, and 8, for example. The AP 105-e may communicate with a core network 980 through the network communications module 970. The AP 105-e may communicate with other APs, such as the access point 105-b and the access point 105-c, using an APs communications module 960.

The multiplexing module 940 may also process information to be sent to the transceiver module 930 for transmission through the quad-polarized antenna array 205-b. For example, the multiplexing module 940 may multiplex one or more signals to be transmitted by the transceiver module 930 via the quad-polarized antenna array 205-b. The multiplexing module 940 may also inverse multiplex one or more signals received by the transceiver module 930 via the quad-polarized antenna array 205-b.

According to the architecture of FIG. 9, the AP 105-e may further include a communications management module 950. The communications management module 950 may manage communications with stations and/or other devices as illustrated in the radio access network 100 of FIG. 1. The communications management module 950 may be in communication with some or all of the other components of the AP 105-e via the bus or buses 905. Alternatively, functionality of the communications management module 950 may be implemented as a component of the transceiver module 930, as a computer program product, and/or as at least one controller element of the processor module 910. The AP 105-e may also communicate with an AP 105-f and/or an AP 105-g.

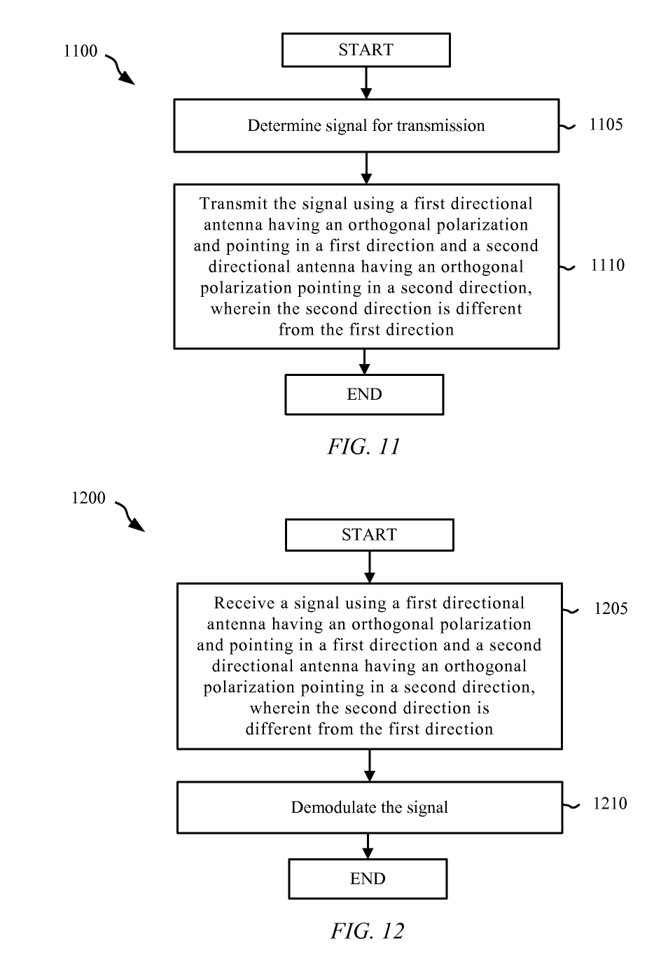

The components of the AP 105-e may be configured to implement aspects discussed above with respect to FIGS. 1-4, 6, and 8, and those aspects may not be repeated here for the sake of brevity. Moreover, the components of the AP 105-e may be configured to implement aspects discussed below with respect to FIGS. 11-12 and those aspects may not be repeated here also for the sake of brevity.

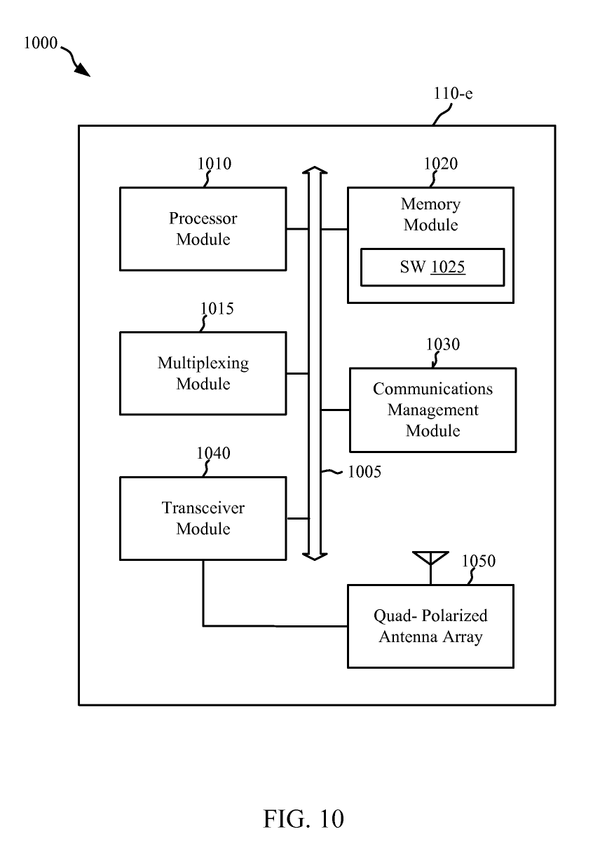

FIG. 10 shows a block diagram 1000 of an example of a wireless station 110-e for use in wireless communication according to an embodiment of the present disclosure. The wireless station 110-e may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless station 110-e may have an internal power supply, such as a small battery, to facilitate mobile operation. The wireless station 110-e may be an example of the wireless stations 110 of FIGS. 1-4, 6, and 8. The wireless station 110-e may be deployed in an outdoor environment.

The wireless station 110-e may include a processor module 1010, a memory module 1020, a transceiver module 1040, quad-polarized antenna array 1050, and a station multiplexing module 1015. The quad-polarized antenna array 1050 may be an example of the antenna arrays 205 of FIGS. 2 and 3, an example of the single quad-polarized antenna 415 of FIG. 4, and/or an example of the single quad-polarized antenna 510 of FIGS. 5 and 6. Each of the modules may be in communication with each other, directly or indirectly, over at least one bus 1005.

The memory module 1020 may include RAM and ROM. The memory module 1020 may store computer-readable, computer-executable software (SW) code 1025 containing instructions that are configured to, when executed, cause the processor module 1010 to perform various functions described herein for outdoor high throughput MIMO applications. Alternatively, the software code 1025 may not be directly executable by the processor module 1010 but be configured to cause the computer (e.g., when compiled and executed) to perform functions described herein.

The processor module 1010 may include an intelligent hardware device, e.g., a CPU, a microcontroller, an ASIC, etc. The processor module 1010 may process information received through the transceiver module 1040 and/or to be sent to the transceiver module 1040 for transmission through the quad-polarized antenna array 1050. The processor module 1010 may handle, alone or in connection with the multiplexing module 1015, various aspects for outdoor MIMO communications.

The transceiver module 1040 may be configured to communicate bi-directionally with APs 105 in FIGs. FIGS. 1-4, 6, and 8-9. The transceiver module 1040 may be implemented as at least one transmitter module and at least one separate receiver module. The transceiver module 1040 may include a modem configured to modulate the packets and provide the modulated packets to the quad-polarized antenna array 1050 for transmission, and to demodulate packets received from the quad-polarized antenna array 1050.

According to the architecture of FIG. 10, the wireless station 110-e may further include a communications management module 1030. The communications management module 1030 may manage communications with various access points. The communications management module 1030 may be a component of the wireless station 110-e in communication with some or all of the other components of the wireless station 110-e over the at least one bus 1005. Alternatively, functionality of the communications management module 1030 may be implemented as a component of the transceiver module 1040, as a computer program product, and/or as at least one controller element of the processor module 1010.

The components of the wireless station 110-e may be configured to implement aspects discussed above with respect to FIGS. 1-4, 6, and 8, and those aspects may not be repeated here for the sake of brevity. Moreover, the components of the wireless station 110-e may be configured to implement aspects discussed below with respect to FIGS. 11-13, and those aspects may not be repeated here also for the sake of brevity.

FIG. 11 shows a flowchart of an example method 1100 to transmit signals using a quad-polarized antenna system according to an embodiment of the present disclosure. For clarity, the method 1100 is described below with reference to aspects of one or more of the APs 105 or wireless stations 110 described with reference to FIGS. 1-4, 6, and 8-10, and/or aspects of one or more of the quad-polarized antennas described with reference to FIGS. 5 and 7. In some examples, a AP 105 or wireless stations 110 may execute one or more sets of codes to control the functional elements of the AP 105 or wireless stations 110 to perform the functions described below. Additionally or alternatively, the AP 105 or wireless stations 110 may perform one or more of the functions described below using-purpose hardware.

At block 1105, the method 1100 may include determining one or more signals for transmission. The signal may be multiplexed by a processor or multiplexing module and provided to a transceiver module. The transceiver module may provide the multiplexed signals to the quad-polarized antenna. The operation at block 1105 may be performed using the processor module 910 and the multiplexing module 940 and/or the processor module 1010 and the multiplexing module 1015 described with reference to FIGS. 9 and 10.

At block 1110, the method 1100 may include transmitting the one or more signals using a first directional antenna having an orthogonal polarization and pointing in a first direction and a second directional antenna having an orthogonal polarization pointing in a second direction, wherein the second direction is different from the first direction. The operation at block 1105 may be performed using the quad-polarized antenna array described with reference to FIGS. 2-10. In some examples of the method 1100, transmitting the signal further includes transmitting the signal using three or four spatial streams.

The method 1100 may further include determining a selected signal path from a plurality of possible signal paths a signal transmitted by the first directional antenna and the second directional antenna could take to a station. In some examples, transmitting the signal further comprises transmitting the signal over the selected signal path. In some examples, determining the selected signal path further includes calculating a matrix for the plurality of possible signal paths. The matrix may be a weighted B matrix. From the weighted B matrix, the method 1100 may select a signal path from the plurality of possible signal paths based at least in part on the matrix. For example, the method 1100, via a processor, may select the best signal path for transmitting to a particular client, such as a station 110.

The method 1100 may repeatedly determine the best signal path for a signal during a transmission. For example, the method 1100 may calculate the matrix for the signal paths once every 1000 milliseconds (ms). Once the processor has determined the best possible signal path, the method 1100 may include only using the signal along the selected signal path and discarding all other signals. The method 1100 may include performing the calculation for each client or station 110. The method 1100 may lead to greater control, higher spectral efficiency, and a better use of scarce wireless channels.

In other examples of the method 1100, more than one signal may be transmitted to more than one client stations 110 at a time. In some examples, the method 1100 uses different signal paths for different stations 110. The different signal path for each client may be a preferred signal path in terms of the best available multipath channel characteristics in the outdoor medium between the AP 105 and the station 110.

In further examples of the method 1100, the first and second directional antennas (e.g., the quad-polarized antenna array) may be tuned. Tuning the quad-polarized antenna array may be achieved, for example, by adjusting an azimuth of the quad-polarized antenna array. The quad-polarized antennas may be tuned in order to exploit any reflective paths in the outdoor wireless environment. In some examples, only one of the first and second directional antennas may be adjusted. The tuning of the quad-polarized antennas may adjust the gain and may be used to achieve a particular SNR. In some examples of the method 1100, the quad-polarized antennas may be repeatedly tuned throughout a transmission. In some examples, tuning the quad-polarized antennas may include using one or more of a backplane reflector and an attenuator. Tuning may also be achieved through material selection of the quad-polarized antennas, selecting the spacing between arrays, and antenna gain control.

In another example, a method for wireless communications may include receiving a signal using a first directional antenna having an orthogonal polarization and pointing in a first direction and a second directional antenna having an orthogonal polarization pointing in a second direction, wherein the second direction is different from the first direction.

Thus, the method 1100 may provide for wireless communication. It should be noted that the method 1100 is just one implementation and that the operations of the method 1100 may be rearranged or otherwise modified such that other implementations are possible.

FIG. 12 shows a flowchart of an example method 1200 to receive signals using a quad-polarized antenna system according to an embodiment of the present disclosure. For clarity, the method 1200 is described below with reference to aspects of one or more of the APs 105 or wireless stations 110 described with reference to FIGS. 1-4, 6, and 8-10, and/or aspects of one or more of the quad-polarized antennas described with reference to FIGS. 5 and 7. In some examples, a AP 105 or wireless stations 110 may execute one or more sets of codes to control the functional elements of the AP 105 or wireless stations 110 to perform the functions described below. Additionally or alternatively, the AP 105 or wireless stations 110 may perform one or more of the functions described below using-purpose hardware.

At block 1205, the method 1200 may include receiving a signal using a first directional antenna having an orthogonal polarization and pointing in a first direction and a second directional antenna having an orthogonal polarization pointing in a second direction, wherein the second direction is different from the first direction. The operation at block 1205 may be performed using the quad-polarized antenna array described with reference to FIGS. 2-10. In some examples of the method 1200, transmitting the signal further includes receiving the signal over three or four spatial streams.

At block 1210, the method 1200 may include demodulating the one or more signals. The signal may be demodulated by inverse multiplexing the received signals. The signals may be demodulated by a processor or multiplexing module. The quad-polarized antenna array may provide the multiplexed signals to the transceiver module, which in turn may provide the multiplexed signals to a processor or multiplexing module. The operation at block 1205 may be performed using the processor module 910 and the multiplexing module 940 and/or the processor module 1010 and the multiplexing module 1015 described with reference to FIGS. 9 and 10, respectively.

The method 1200 may further include tuning the quad-polarized antenna array (e.g., the first directional antenna and the second directional antenna) in order to receive the one or more signals.

Thus, the method 1200 may provide for wireless communication. It should be noted that the method 1200 is just one implementation and that the operations of the method 1200 may be rearranged or otherwise modified such that other implementations are possible.

Regarding the signals and network communications described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiments are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An apparatus for wireless communications, comprising:
an antenna array for multiple-input, multiple-output (MIMO) wireless communication, comprising:
a first directional antenna having an orthogonal polarization, wherein the first directional antenna is pointed in a first direction;
a second directional antenna having an orthogonal polarization, wherein the second directional antenna is pointed in a second direction different from the first direction; and
a third directional antenna having an orthogonal polarization pointed in a third direction, wherein the third direction is different from the first direction and the second direction;
wherein the first and second directions are approximately 45 degrees apart.

2. The apparatus of claim 1, wherein the first directional antenna and the second directional antenna are spatially separated in order to reduce correlation.

3. The apparatus of claim 1, wherein the first and second directional antennas transmit and receive the wireless communications over four spatial streams.

4. The apparatus of claim 1, wherein the first and second directions are approximately antiparallel.

5. (canceled)

6. The apparatus of claim 1, wherein the antenna array comprises an access point, wherein the first and second directional antennas transmit and receive MIMO wireless communications to and from a station comprising a single directional antenna with quad polarities.

7. The apparatus of claim 1, wherein the antenna array comprises one of an access point and a station.

8. The apparatus of claim 1, wherein a boresight of the antenna array is rotated approximately ninety degrees with respect to a receiving station.

9. The apparatus of claim 1, wherein the first directional antenna and the second directional antenna each comprise two dipole antennas.

10. An apparatus for multiple-input multiple-output (MIMO) communications, comprising:
an antenna array comprising four dipole antennas having slant vertical polarization configured orthogonally.

11. The apparatus of claim 10, wherein each of the four dipole antennas has a gain of at least 5 dBi.

12. The apparatus of claim 11, wherein the gain of the four dipole antennas sustains three or four spatial streams.

13. The apparatus of claim 10, wherein the antenna array is a first antenna array, wherein the first antenna array communicates with a second antenna array comprising four dipole antennas having slant vertical polarization configured orthogonally.

14. The apparatus of claim 13, wherein the first antenna array is within approximately 80 meters of the second antenna array and in line-of-sight.

15. The apparatus of claim 13, wherein a boresight of the first antenna array is rotated at least ninety degrees with respect to the second antenna array.

16. A multiple-input multiple-output (MIMO) wireless communication system, comprising:
an access point, comprising:
a first directional antenna having an orthogonal polarization, wherein the first directional antenna is pointed in a first direction;
a second directional antenna having an orthogonal polarization, wherein the second directional antenna is pointed in a second direction different from the first direction;
a third directional antenna having an orthogonal polarization, wherein the third directional antenna is pointed in a third direction different from the first and second direction; and
a station configured to communication with the access point;
wherein the first and second directions are approximately 45 degrees apart.

17. The system of claim 16, wherein the station further comprises:
a fourth directional antenna having an orthogonal polarization, wherein the fourth directional antenna is pointed in a fourth direction different from the first, second, and third direction.

18. The system of claim 16, wherein the station further comprises a single directional antenna with quad polarities.

19. The system of claim 16, wherein the first and second directions are approximately antiparallel.

20. (canceled)

21. The system of claim 16, wherein the access point and the station communicate using a wireless local area network (WLAN) or a cellular network.

22. The system of claim 16, wherein the access point is configured to use three or four spatial streams for transmitting a signal to the station.

23-27. (canceled)
